(19) United States
(12) Patent Application Publication
(10) Pub. No.: US 2017/0010471 A1
(43) Pub. Date: Jan. 12, 2017

(54) GRAPHIC DISPLAY ADAPTER DEVICE FOR MOBILE VIRTUAL STEREOSCOPIC VISION

(71) Applicant: ImmersiONVRelia, Inc., Redwood City, CA (US)

(72) Inventors: Daniel Serrano Canovas, Murcia (ES); Jose Antonio Garcia Marin, Murcia (ES); Francisco Alvarez Beltran, Murcia (ES); Alvaro Redondo Caparros, Murcia (ES); Jose Francisco Castejon Mochon, Murcia (ES); Fernando Vargas-Martin, Murcia (ES)

(21) Appl. No.: 14/792,366

(22) Filed: Jul. 6, 2015

(51) Int. Cl. G02B 27/01; G06T 19/00; G02B 27/22

(52) U.S. Cl. CPC G02B 27/0176; G02B 27/2228; G06T 19/006

(57) ABSTRACT

An adapter device is provided to be disposed on the wearer's head. A mobile phone or other mobile graphical device can be inserted in the front of the device so this is opposite the user's eyes at a short distance. The device also incorporates lenses and adjustment mechanisms of the lenses that allow proper display of the graphic display device that is inserted in the adapter. Thus the device is designed to achieve stereoscopic 3D vision, configuring the adapter assembly and the device graphic as a device that allows multiplexing (two or more information channels on a single means of transmission) for position (side-by-side) in a mobile phone or other device with graphic screen TV, merging both visual content and receiving a three-dimensional image.

### RELATED APPLICATION

This application is related to Spanish Patent Application No. 201400428, filed May 16, 2014, the entirety of which is hereby incorporated by reference.

### BACKGROUND

Field

The device proposed herein uses a mobile imaging device to generate stereoscopic images so that the user can employ a depth sensation equivalent to the usual experience of vision. It can be used for multimedia content reproduction in many applications, such as, but not limited to, education, medicine, psychology, architecture, training in different disciplines, video games, entertainment, augmented reality, productivity tools, simulators, military applications, etc.

Embodiments of devices described herein can have application in many different fields, including virtual reality (VR) or augmented reality fields.

Description of the Related Art

The stereoscope was invented in 1840 and consisted of an appliance device showing two slightly different planar images. The images are merged in a viewer's brain to create a sense of depth. From this early device to the present, countless variations and innovations of stereoscopic devices have been created with varying commercial success.

Various adapters are known that allow viewers to incorporate a mobile device for functions described herein. However, embodiments described herein include feature that are not known and resolve several of the problems common to conventional devices.

Some conventional devices are described in the following references:

DE202013103458 discloses a support device for a display screen, comprising a frame with two separate sections, where a first section is housed on the head of a user and a second section is described as the mounting support device in which a electronic display unit is received. Between the two sections there is at least one optical condenser lens. The partition (7) of this design does not completely separate both parts of the stereoscope, so that an eye can perceive pictures intended partially for the opposite eye. The mobile graphical device is housed on four elastomer pads (14) and are set by closing a lid (15) that does not cover the device completely, so that this device is subject to the danger of accidental falls. The separation between lenses is adjusted by a guide element (9) which lacks the possibility of a fine adjustment, which can present an issue where tenths of a millimeter accuracy is necessary to avoid visual discomfort to the wearer. The adapter is only configured to attach to the user's head by a horizontal band, which in the end can result in undesirable shifting of the device.

U.S. Publication No. 2012/0026298A1 describes a method and an apparatus for producing images for stereoscopic, three-dimensional viewing generated with mobile graphical devices. Two reflectors, which may be mirrors or prisms, are positioned to separate the field of view of a camera lens on the mobile graphical device into a direct field of view and an offset field of view and to record and display the separated fields in a two-paned format on the mobile graphical device. Eye lenses are used to separately view the split images. An integrated housing and cradle receive the mobile graphical device and are coupled to the reflectors and the eye lenses. The housing of the apparatus of US2012/0026298A1 has holes (84) for access to a touch screen for user control of the mobile device, which for space reasons results in increased dimensions of the device which makes it difficult to hold the device to the wearer's head with straps. Thus, the apparatus is designed to be held with hands like binoculars. Furthermore, in this device eye lenses (66, 68) are fixed, with no possibility of adapting to different biometric characteristics of different users and no possibility for focus adjustment.

U.S. Publication No. 2013/0194682A1 describes a display that has a frame that adjustably holds a pair of lenses. The frame has tracks along a bottom inside portion that guides the lenses as a lens adjustment knob is turned. The adjustment knob is attached to a translating screw shaft that has opposingly threaded portions that interact with a left and right traveling nut attached to each lens and moves each lens in an opposite direction. An elastic strap is used to removably hold a personal media device to the frame and a head attachment portion is provided to allow a user to operate the personal media viewing device hands free. The mobile graphical device is held by a strap that adjusts the visor by pressure, lacking another anchoring element to prevent unwanted movement of the mobile graphical device. The lenses of this device are only provided with horizontal movement, vertical adjustment is not needed to arrange the same size frame. The adjustment system of the lenses is different from that described herein, which is considerably more simplistic and in addition allows independent movement of the lenses.

U.S. Design Pat. No. D701206 is an industrial design of a prototype. Other documents with some degree of relationship to embodiments described in this application are:

International Publication No. WO2012035174 describes a visor with magnifying focal lenses for viewing stereoscopic 3D content on mobile graphical devices, positioning the mobile graphical device in front of the lenses using guides designed for a wide variety of devices. This device is configured from several flat pieces which are inserted into each other, and has a number of anchors that stiffen the set and give stability to the mobile graphical device. While this device is related to embodiments described herein in that it uses a stereoscope of a mobile graphical device for visualization, it has no ability to adjust the lens, which are fixed, and thus also does not offer the possibility of acceding to the mobile graphical device adjustment of position. While the document WO2012035174 describes the possibility of incorporating straps to arrange the device on the user's head and leave the hands free, it only describes anchors for a horizontal belt.

U.S. Publication No. 2004/0061663 describes a device having the ability to generate images, which employs elements in the device for generating a sense of depth to the user.

CA2673387 describes a simple stereoscope model adapted for insertion of mobile graphical devices.

ES 1034753 describes a removable stereoscope.

U.S. Design Pat. No. D444155 is an industrial design of a prototype for virtual reality having certain aesthetic similarities with devices described herein.

There are also several companies that produce visors to use phones or portable devices like virtual reality visors:

Durovis Dive has a lens movement system by means of a stick that contains a part for holding the lens and moves across two rails. It allows adjustment of the interpupillary distance and focus. The optic system displaces easily once the device is being used and lacks a barrier or mask, creating a jarring effect to see part of the image for the other eye, creating strange images or artifacts in the periphery of the visual field. This company is assignee of patent application DE202013102458U1.

VRase: This company makes devices that feature interpupillary distance adjustment but not focus adjustment for correction of visual defects. It is available through a single horizontal strap. It also employs a lens arrangement of a size that makes it unnecessary to use a separator to prevent mixing images intended for each eye.

360specs: This company shows a device where the mobile graphical device is inserted on guides to be placed in front of the eyes of the user. This device is used with a horizontal band that holds it to the head. It uses two lenses of large size that have no possibility of adjustment.

Other companies offering devices that are related to the subject matter herein, with different variations but lack the configuration or functionality of devices described herein are Lakento, Altergaze, Refugio3D, VR2G0 and PlayStep3drv.

Other types of stereoscopic electronic devices are called Head Mounted Displays, also called in some professional fields alternately Head Up Displays or Head Worn Displays. Within this type the NEAR Eye Displays are based on installing one or two micro image monitors as close to the eye as possible, by specific optical image formed on the retina. The current trend is that the image does not interfere with normal vision, so that they are viewed simultaneously. This property is very useful in Augmented Reality systems in many applications. This is because in certain applications, a large field of view is crucial to get a sense of immersion and realism, other types of devices that are based on immersive displays, that is, with a restriction of the visual field that is not proportional to the visor display. Devices described herein are based in the operation of a stereoscope by binocular multiplexing side-by-side.

### SUMMARY

Embodiments of devices described herein are designed to comfortably fix mobile smart devices with flat image or video screens, such as tablet computers, video game consoles, flat video screens, etc. to the head of the user at eye level. The device may include a pair of converging optical systems with individual displacement which allows each eye of the user to compensate for the observation distance and correction of spherical equivalent refraction necessary to relax the accommodation, as well as adapt to the interpupillary distance (IPD) of the user and the required binocular convergence.

The viewer can display images or stereoscopic video represented on mobile device screens so that it is not necessary to use hands or any other support to secure the mobile graphical device, in whatever movement or position of the user's head. This visualization is immersive in that the visor blocks in one eye the illumination of other light sources apart from the zone of the desired screen.

The visor that is configured from a main body or mask, an optical system, a barrier or mask, a fastening and anchor system for a mobile graphical device, and side and top clamping.

The main body is provided in contact with a user's face in an ergonomic geometry that adapts to the curvature of the head of a person. In this embodiment, the contact area has a strap of flexible elastomer material that enables the user to adequately adjust the device, so as to prevent light from the exterior from reaching the user's eyes, thereby configuring an immersive experience of the device. Both in the sides and the top of the main body, anchors are arranged for the straps of the user's head. Finally in the front of the main body there is a tray for holding the mobile graphical device.

In this embodiment, the lateral sides of the main body have controls for adjusting the lenses. By a pair of rack and pinion mechanisms, it is possible to very precisely adjust the focus of the lens moving forward and backward just the distance needed, achieving the precision of movement that is very important since a deviation of tenths of a millimeter with respect to the ideal position can cause a loss of quality of the image received by the user as well as discomfort and eyestrain. On the other hand, the interpupillary distance can be adjusted by two rods also arranged at the sides of the main body. Said rods are fastened by friction with the same support of the main body where they are embedded. The inside the support may be coated with any elastomer material to increase the friction.

The optic system can include a pair of converging lenses and corresponding supports and actuators for positioning. Through precise and continuous movement (that is, the movement is not staggered in different positions, but can be placed within any position within a range) in two perpendicular axes, this system allows adjustment in each individual eye of the interpupillary distance to the center of vertical symmetry and of the display lens distance for correction of spherical equivalent refraction errors and for compensation of display distance without using glasses or lenses exterior to the system. It is therefore possible to correct various diopters, negative as well as positive, that the user may have.

Lens settings are made individually for each lens without need for taking the device off the face once placed. The interpupillary adjustment in turn controls the projection of each primary or preferential visual axis, on the screen, through prismatic effect by decentration according to Prentice's Rule. This allows use of different size screen, especially those of smaller dimensions that do not allow for central correction of the projections of each visual axis.

The device also has a barrier or mask that includes a partition (hereinafter defined as a “septum”) that precisely prevents seeing in one eye an image that is intended for the opposite eye, allowing the lens and display to be approximated to the user to a large degree, which provides greater immersion in the virtual environment.

The system for securing the phone (or other mobile graphical device) consists of a tray coupled to the main body with one or more hinges arranged at its bottom, so that in case of accidental fall of the device after opening the tray the device falls on the tray, minimizing the consequences of the event. The tray, as part of the main body on which the user places the mobile graphical device, is provided with elastomeric material to avoid possible downward or landslide adjustment of the screen position. The tray also has front openings to leave unobstructed the camera lens of the mobile graphical device and allow repositioning of the device to its ideal position. The tray also has side openings for optional connections to headphones or external power connections. Once the phone (or other mobile graphical device) is inserted, the tray is closed and fixed with a latch, ready to place the device on the user's head.

The securing belts consist of two elastic bands, one horizontal that is anchored to the sides of the main body, the other vertical that is anchored to the top part of the main body and joins the center of the horizontal belt by a junction element common for such uses. The straps have mechanisms for pressure adjustment.

The visor allows the use of position and displacement sensors, both external such as those integrated in the mobile graphical device, as well as suitable software constituting a complete three-dimensional virtual reality vision system for representation of and interaction with virtual worlds.

### BRIEF DESCRIPTION OF THE DRAWINGS

FIG. 1 is a perspective view of the visor, with the tray closed and without a mobile graphical device.

FIG. 2 is another perspective view of the visor, this time arranged on a user's head and a mobile graphical device inserted.

FIG. 3 is a rear perspective view of the visor, without a mobile graphical device.

FIG. 4 is view of the device from the perspective of FIG. 1, this time with the tray open to observe the interior of the visor.

FIG. 5 is a rear elevational view of the visor.

FIG. 6 is a profile view of the visor.

FIG. 7 is a disassembled view of components of the optics system of the visor.

### DETAILED DESCRIPTION

Embodiments of the device will now be described with reference to the figures, which are not intended to be limiting.

An adapter device is provided to be disposed on the wearer's head. A mobile phone or other mobile graphical device can be inserted in the front of the device so this is opposite the user's eyes at a short distance. The device also incorporates lenses and adjustment mechanisms of the lenses that allow proper display of the graphic display device that is inserted in the adapter. Thus the device is designed to achieve stereoscopic 3D vision, configuring the adapter assembly and the device graphic as a device that allows multiplexing (two or more information channels on a single means of transmission) for position (side-by-side) in a mobile phone or other device with graphic screen TV, merging both visual content and receiving a three-dimensional image.

Embodiments of the adapter devices described herein can extend the functionality of mobile phones and other similar devices (hereafter referred to this as “mobile graphical devices”), creating virtual reality glasses, augmented reality or mixed reality (also known as increased) virtually by combining adapter and mobile graphical devices. The particular characteristics of this adapter solve many of the problems in existing similar devices today, while incorporating new elements that provide it with functionalities which to date it was not possible to offer.

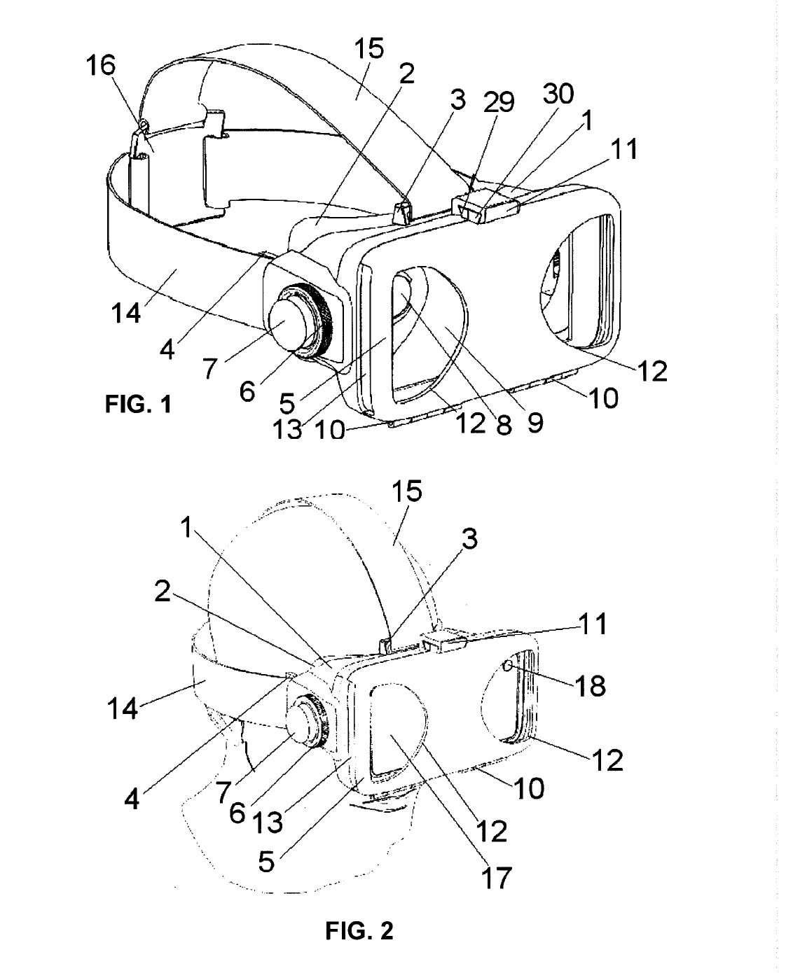

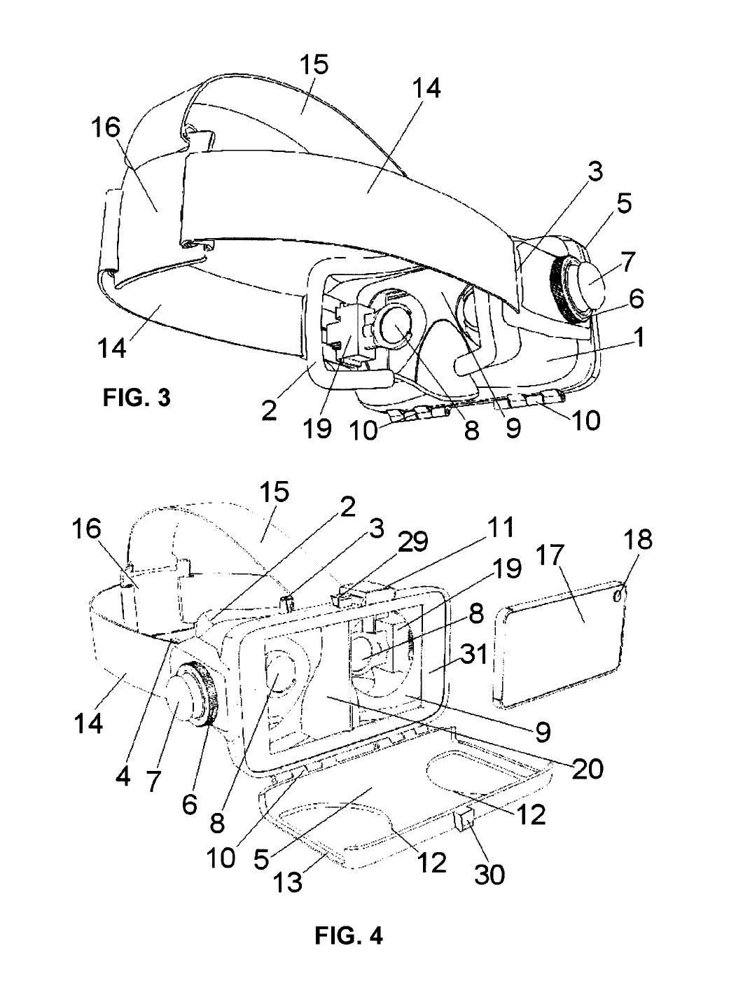

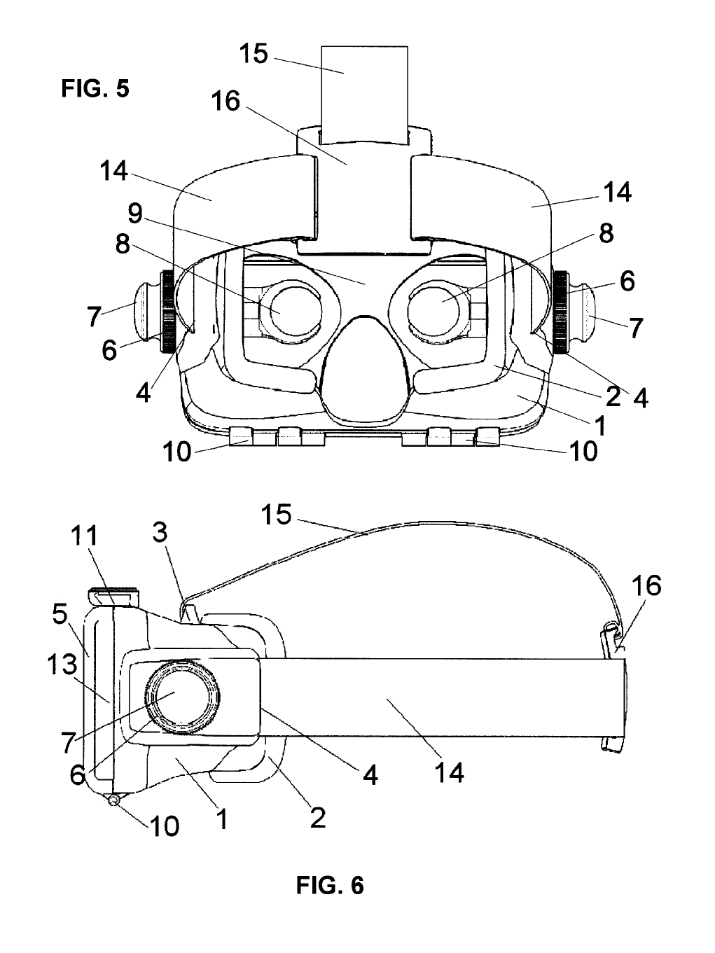

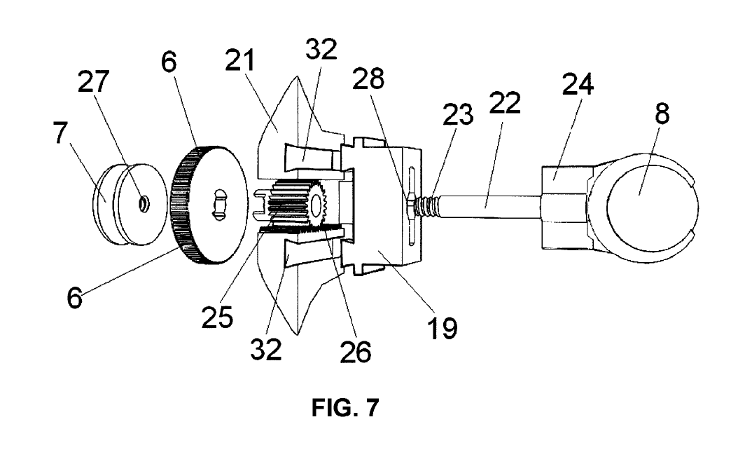

As shown in FIGS. 1-7, the visor is configured with a main body (1), having a geometry similar to welding glasses. The main body (1) is coupled to the user's face in the contact area with a band of elastomeric material (2) that allows full adjustment to the user's face, completely preventing the entry of outside light. The main body has on its side an adjustment wheel (6) for the lenses (8) as well as an the adjustment rod (7) for lenses (8). Through use of the wheel (6) and the rod (7) it is possible to adjust both lens-screen distance as well as the interpupillary distance. Also in the lateral side there are arranged side anchors (4) for the horizontal strap, while in the top part there is a top anchor (3) for the vertical strap (15).

In the front of the main body (1) there is a tray (5) for the mobile graphical device (17), both elements being connected by hinges (10) situated at the bottom front of the main body (1). In this way the tray (5) is opened downward, minimizing the possibility that the mobile graphical device (17) will fall when the tray (5) is opened. Anchoring the tray (5) against the main body (1) is by a closure (11) which fits on a mobile flange disposed in the main body (29) and another flange arranged in the tray (30). Embodiments of the device can thus include the tray (5) that can be easily be opened and closed by touch, without the need to observe the mechanism.

In the area of the main body (1) supporting the mobile graphical device (17), which is designated frame (31), a band of elastomeric material is provided that prevents movement of mobile graphics device (17) once located on its position of use.

The tray (5) has front openings (12) that allow fingers to access the mobile imaging device (17) to adjust its position properly when the tray (5) has already been closed. In addition, these openings (12) leave unobstructed the lens or lenses of mobile graphical device (18) for augmented reality applications. Also, the tray (5) has side openings (13) for connection of accessories of the mobile imaging device (17) such as a speaker, batteries, etc.

In the contact area of the tray (5) with the mobile graphical device (17), there is also a band of elastomeric material with the same purpose as the band arranged on the outside of the frame (31) of the main body (1).

The main body (1) has coupled to its inside portion a mask (9) which fits over the wearer's face and prevents the entry of light from outside. The mask (9) has in the area of the user's nose a wall or septum (20) that divides the field of view of the screen of the mobile graphical device (17) in two independent parts, separating the optical channels for each eye. In this way it guarantees the impossibility that one eye receives images intended for the opposite eye. The mask assembly (9) and septum (20) allow the lenses (8) to approximate to a large degree the screen of the mobile graphical device (17), thus creating an immersive experience for the user.

The optical system of the visor consists of a pair of lenses (8) which are arranged to converge independently of each on a support (24) the which is attached to a rod (22) which has a threaded end (23) screwed on a threaded hole (27) disposed in the rod (7), wherein said rod (7) is within reach of the user to adjust the lens (8) in the longitudinal direction of the rod (22), so that adjustment of the interpupillary distance is possible. Adjusting the distance from the lens (8) to the mobile graphical device (17) is performed by a pinion (25) and rack (26) mechanism which is driven by rotating a wheel (6) arranged on the side of the main body (1) within reach of the user.

The rack (26) is located on a support (21) which has space for entry of a pinion (25), which upon rotation advances rack (26) and support (21). This support (21) has guides (32) which fits on a carriage (19) that is attached to the rod (22), transmitting to the lens (8) movement of the wheel (6). The rod (22) is fixed to the support assembly (21) and carriage (19) by friction with the inside of the carriage (28).

The coupling of the visor to the user's head is made by a horizontal band (14) and a vertical band (15) which are joined at the back of the head through a tensioner (16) that allows precision adjustment of the bands on the head of user.

Having sufficiently described the nature of the present invention and how to put it into practice, it is not considered necessary to expand its explanation for any expert in the art to understand its scope and the advantages that flow from it, stating that, in its essence, may be put into practice in other embodiments which differ in detail from the indicated by way of example, and which are also protected without altering, changing or modifying its fundamental principle.

What is claimed is:

1. A mobile graphics adapter virtual stereoscopic vision device comprising:
a main body;
holding a tray attached to the front of the main body by hinges;
a lens; and
strips fastening to the user's head,
wherein the main body has on its sides a wheel to the lens and an adjustment rod also for lenses also providing lateral anchors for clamping the horizontal belt and at the top an upper anchor for holding the vertical strap where the hinges are arranged in the bottom of the main body and the tray,
wherein the tray holding has front openings and side openings wherein the main body has coupled thereto on the inside of a mask which fits over the user's face,
wherein said mask has in the area of the user's nose with a wall or septum dividing the field of view of the mobile graphics display device into two separate parts where the setting wheel drives a pinion mechanism and pinion moving the lens continuously varying lens-screen distance,
wherein actuation of the rod can move perpendicular to the lens movement provided by the drive wheel sense.

2. The mobile graphics display adapter virtual stereoscopic vision devices according to claim 1, wherein the main body has in the region of contact with the user's face of a band of elastomeric material.

3. The mobile graphics display adapter virtual stereoscopic vision devices according to claim 1, wherein the anchor plate against the main body is performed by a closure fits on a moving flange arranged on the main body and another tab disposed on the tray.

4. The mobile graphics display adapter virtual stereoscopic vision devices according to claim 1, characterized in that the frame of the main body, a band of elastomeric material is arranged and in the contact zone of the tray with mobile graphics device.

5. The mobile graphics display adapter virtual stereoscopic vision devices according to claim 1, characterized in that the openings of the tray allows to free the lens or the mobile imaging device lenses.

6. The mobile graphics display adapter virtual stereoscopic vision devices according to claim 1,
wherein the pair of lenses which are arranged converging independently each on a support which is attached to a rod which has a threaded end which is screwed onto an inner threading of the shaft, wherein said rod is accessible to the user to adjust the lens in the longitudinal direction of the rod,
wherein the rack is located on a support which has a space for entry of a pinion is advanced by rotating rack and support where this support has guides which fits on a carriage connected to the rod and transmitted to the lens the movement of the wheel,
wherein the rod is fixed to the support assembly and carriage by friction with the inside of the carriage.
